(19) United States
(12) Patent Application Publication
(10) Pub. No.: US 2012/0145908 A1
(43) Pub. Date: Jun. 14, 2012

(54) RADIOGRAPHIC IMAGE CAPTURE DEVICE, RADIOGRAPHIC IMAGE CAPTURE METHOD, AND RADIOGRAPHIC IMAGE CAPTURE PROGRAM STORAGE MEDIUM

(75) Inventor: Keiichiro SATO, Kanagawa (JP)

(73) Assignee: FUJIFILM CORPORATION, Tokyo (JP)

(21) Appl. No.: 13/298,302

(22) Filed: Nov. 17, 2011

(30) Foreign Application Priority Data
Dec. 10, 2010 (JP) 2010-275691

(51) Int. Cl. G01T 1/202; G01T 1/20

(52) U.S. Cl. 250/362; 250/366

(57) ABSTRACT

A radiographic image capture device includes a wavelength conversion layer that converts radiation that has passed through an imaging subject into visible light, a first photodetector that detects the converted visible light and that converts the converted visible light into a first image signal expressing a radiographic image, a second photodetector that detects the converted visible light and that converts the converted visible light into a second image signal expressing a radiographic image, and a synthesizing section that combines the first image signal read from the first photodetector and the second image signal read from the second photodetector such that misalignment between the first and the second photodetectors is eliminated.

### CROSS-REFERENCE TO RELATED APPLICATION

This application claims priority under 35 USC 119 from Japanese Patent Application No. 2010-275691 filed on Dec. 10, 2010, the disclosure of which is incorporated by reference herein.

### BACKGROUND OF THE INVENTION

1. Field of the Invention

The present invention relates to a radiographic image capture device, a radiographic image capture method and a radiographic image capture program storage medium.

2. Description of the Related Art

Radiation detectors are recently being put into practice such as Flat Panel Detectors (FPDs) that have a radiation-sensitive layer disposed above a Thin Film Transistor (TFT) active matrix substrate, detect irradiated radiation such as X-rays and output an electrical signal indicating a radiographic image representing the detected radiation. Such radiation detectors have the advantage of enabling more immediate image and video image confirmation than conventional imaging plates.

Portable radiographic image capture devices (also referred to below as electronic cassettes) for capturing radiographic images installed with such radiation detectors are also being put into practice. It is important in surgery to be able to display a radiographic image immediately after image capture in order to rapidly and accurately treat a patient. Electronic cassettes enable rapid image checking and are able to address such a requirement.

Raising the sensitivity of radiation detection is desirable in radiographic image capture devices using such radiation detectors for radiographic image capture.

Hence, in Japanese Patent No. 3333278 there is a description of a radiographic image detector configured with a photodetector disposed on the side radiation is irradiated onto, and a scintillator disposed on the opposite side to the radiation irradiation side.

In this radiographic image detector, as shown in FIG. 11A, a photodetector 104 configured by a support member 100 and photodiodes 102 is disposed on the incident side of radiation X, and a scintillator 106 is disposed on the radiation X penetration side. Emission intensity marks 108 are shown in FIG. 11A to clarify the magnitude of the emission intensity. As shown in FIG. 11B, the larger the size of the emission intensity marks 108, the higher the emission intensity.

Conventionally, as shown in FIG. 12A, the scintillator 106 is generally disposed on the radiation X incident side. In such a configuration, due to radiation being attenuated by the scintillator 106 and then being detected with the photodetector 104, there is poor detection efficiently for light of high emission intensity on the radiation incident side of the scintillator 106. In contrast, in the configuration illustrated in FIG. 11A, there is good detection efficiency for light of high emission intensity on the radiation incident side due to the photodetector 104 being disposed on the radiation incident side of the scintillator 106.

However in the technology described in Japanese Patent No. 3333278, due to the radiation emission side of the scintillator 106 being far from the photodetector 104, the detection efficiency of light of low emission intensity on the radiation emission side of the scintillator 106 is just as poor as in the conventional configuration illustrated in FIG. 12A.

In Japanese Patent No. 3717530 there is a description of a radiographic image detector having, as shown in FIG. 13, two photodetectors 104A and 104B stacked on one another between scintillators 106A and 106B.

However, in the technology described in Japanese Patent No. 3717530, due to the radiation incident to the one scintillator 106A being further attenuated by the two photodetectors 104A and 104B before being incident to the other scintillator 106B, poor detection efficiency results for light at the other scintillator 106B.

There is also a radiographic image detector described in Japanese Patent Application Laid-Open (JP-A) No. 2010-185882 with a configuration provided with a photodetector for converting incident light into electrical energy on both faces of a scintillator that outputs light according to the intensity of radiation incident thereto.

There is also a description in JP-A No. 7-264483 of a method for aligning radiographic images. When two sheets of photo-stimulated phosphor sheets are superimposed on each other and image capture performed, the positions of plural characteristic points in an image on one of the sheets and the positions of corresponding points in the image of the second sheet are detected, and positional alignment is performed.

However, in the technology described in JP-A No. 2010-185882, when there is misalignment of the two photodetectors, there may be deterioration in image quality due to misalignment when the detected images from the respective photodetectors are superimposed on each other.

In the technique described in JP-A No. 7-264483 there is a high image processing load due to the need to detect the positions of plural characteristic points in the image of one sheet and the positions of the corresponding points in the image of the second sheet. There may also be deterioration in image quality of the superimposed image when the characteristic points are not be detected appropriately.

### SUMMARY

In consideration of the above circumstances, the present invention provides a radiographic image capture device, a radiographic image capture method and a radiographic image capture program-stored medium capable of raising the image quality of an image synthesized from radiographic images detected by two photodetectors.

A first aspect of the present invention is a radiographic image capture device including: a wavelength conversion layer that converts radiation that has passed through an imaging subject into visible light; a first photodetector that detects the visible light converted by the wavelength conversion layer and converts the detected visible light into a first image signal expressing a radiographic image; a second photodetector that detects the visible light converted by the wavelength conversion layer and converts the detected visible light into a second image signal expressing a radiographic image; and a synthesizing section that synthesizes the first image signal read from the first photodetector and the second image signal read from the second photodetector such that misalignment between the first and the second photodetectors is eliminated.

According to the present invention, the image quality of a synthesized image can be improved due to the first image signal read from the first photodetector and the second image signal read from the second photodetector being combined such that misalignment between the first and the second photodetectors is eliminated. In the first aspect of the present invention, the misalignment may be misalignment in a face direction.

Configuration may also be made such that the wavelength conversion layer is interposed between the first photodetector and the second photodetector. The light detection efficiency can be improved according to such a configuration.

Configuration may be made such that the synthesizing section synthesizes the first image signal read from the first photodetector and the second image signal read from the second photodetector according to a misalignment amount between the first photodetector and the second photodetector stored in advance in a storage section such that the misalignment is eliminated.

Configuration may also be made such that the synthesizing section synthesizes the first image signal and the second image signal such that the misalignment is eliminated according to a position of a pixel having a different signal value from other pixels in a first reference image signal of a reference image detected by the first photodetector and in a second reference image signal of the reference image detected by the second photodetector

Configuration may also be made such that the synthesizing section synthesizes the first image signal and the second image signal such that the misalignment is eliminated according to results of pattern recognition performed on the first image signal and the second image signal when an image of an imaging subject is captured.

Configuration may also be made such that the wavelength conversion layer is configured with columnar shaped crystals of CsI:Tl, CsI:Na, or NaI:Tl deposited on a support member of either the first photodetector or of the second photodetector.

Such a configuration may be made with the other photodetector from out of the first photodetector and the second photodetector disposed on the leading end side of the columnar shaped crystals and on the radiation incident side.

Configuration may be made such that the first photodetector includes a first drive circuit that drives the first photodetector and a first read-out circuit that reads out the first image signal; the second photodetector includes a second drive circuit that drives the second photodetector and a second read-out circuit that reads out the second image signal; and the first drive circuit and the first read-out circuit are disposed so as not to face the second drive circuit and the second read-out circuit.

A second aspect of the present invention is a radiographic image capture method including: reading out a first image signal expressing a radiographic image from a first photodetector that detects visible light that was converted into visible light from radiation that passed through an imaging subject by a wavelength conversion layer and converts the detected visible light into the first image signal; reading out a second image signal expressing a radiographic image from a second photodetector that detects visible light that was converted by the wavelength conversion layer and converts the detected visible light into the second image signal; and synthesizing the first image signal and the second image signal such that misalignment between the first and the second photodetectors is eliminated.

According to the second aspect of the present invention, the image quality of a synthesized image can be improved due to the first image signal and the second image signal being combined such that the misalignment between the first photodetector and the second photodetector is eliminated.

A third aspect of the present invention is a non-transitory storage medium storing a program that causes a computer to execute radiographic image capture processing, the radiographic image capture processing including: reading out a first image signal expressing a radiographic image from a first photodetector that detects visible light that was converted into visible light from radiation that passed through an imaging subject by a wavelength conversion layer and converts the detected visible light into the first image signal; reading out a second image signal expressing a radiographic image from a second photodetector that detects visible light that was converted by the wavelength conversion layer and converts the detected visible light into the second image signal; and synthesizing the first image signal and the second image signal such that misalignment between the first and the second photodetectors is eliminated.

According to the third aspect of the present invention, the image quality of a synthesized image can be improved due to the first image signal read from the first photodetector and the second image signal read from the second photodetector being combined such that the misalignment between the first photodetector and the second photodetector is eliminated.

As described above, the aspects of the present invention can improve the image quality of an image synthesized from radiographic images detected by two photodetectors.

### BRIEF DESCRIPTION OF THE DRAWINGS

An exemplary embodiment of the present invention will be described in detail based on the following figures, wherein:

FIG. 1 is a cross-section view schematically illustrating a configuration of a radiation detector;

FIG. 2 is a plan view illustrating a configuration of a radiation detector;

FIG. 3 is a cross-section view illustrating a configuration of a radiation detector;

FIG. 4A and FIG. 4B are cross-section views illustrating a configuration of a radiation detector;

FIG. 5 is a perspective view illustrating a configuration of a flat plane shaped electronic cassette;

FIG. 6 is a cross-section view illustrating a configuration of a flat plane shaped electronic cassette;

FIG. 7 is block diagram illustrating relevant configuration portions in an electrical system of an electronic cassette;

FIG. 8A, FIG. 8B and FIG. 8C are perspective views illustrating connection configurations between radiation detectors and gate line drivers and signal processing sections;

FIG. 9 is a flow chart of processing executed in an electronic cassette;

FIG. 10A and FIG. 10B are explanatory diagrams regarding misalignment of photodetectors;

FIG. 11A and FIG. 11B are explanatory diagrams regarding emission intensity in a conventional radiation detector;

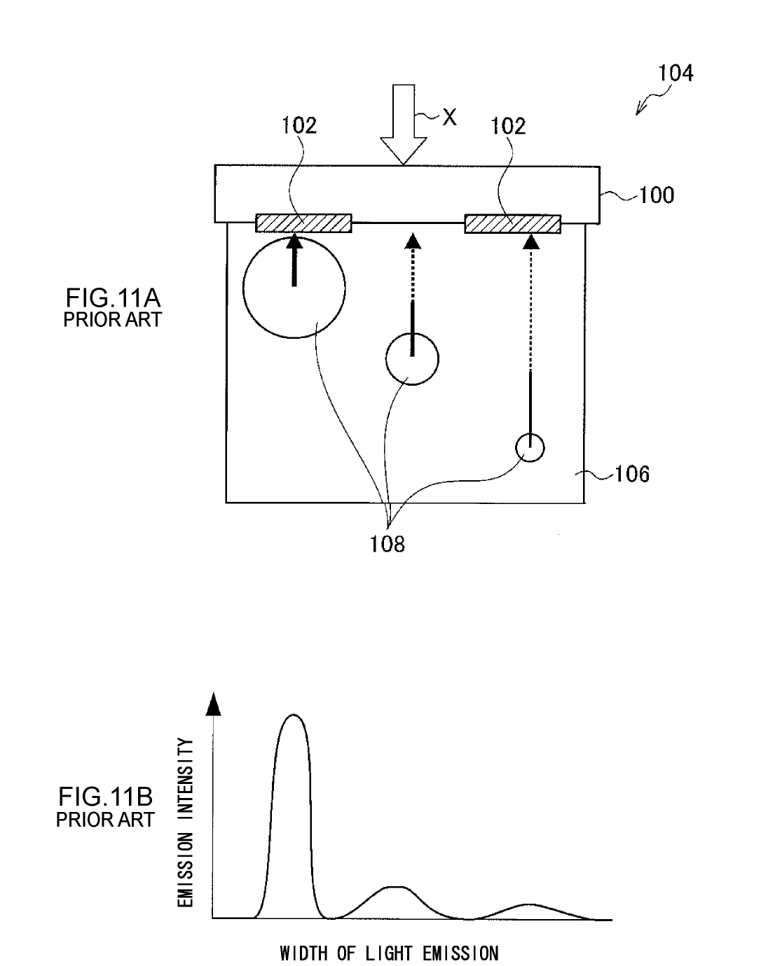

FIG. 12A and FIG. 12B are explanatory diagrams regarding emission intensity in a conventional radiation detector; and

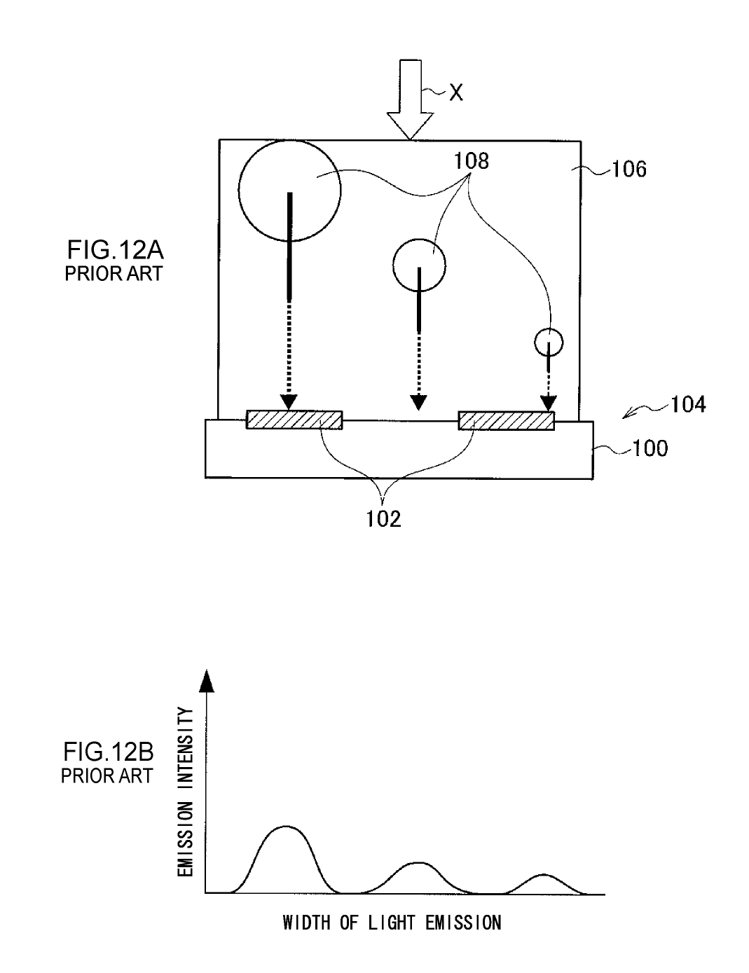

FIG. 13 is an explanatory diagram regarding emission intensity in a conventional radiation detector.

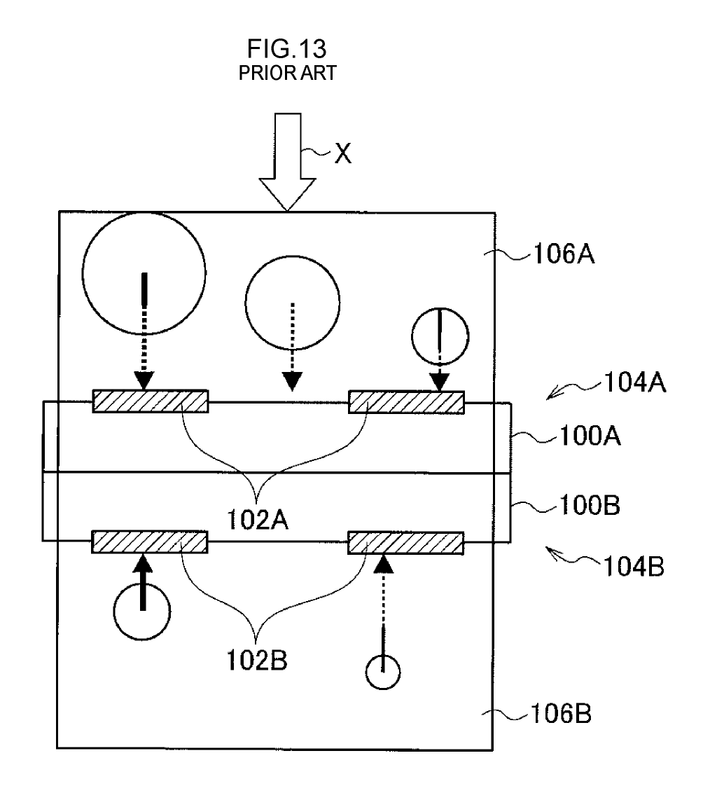

### DETAILED DESCRIPTION

Explanation regarding a configuration of a radiation detector 12 according to the present embodiment follows.

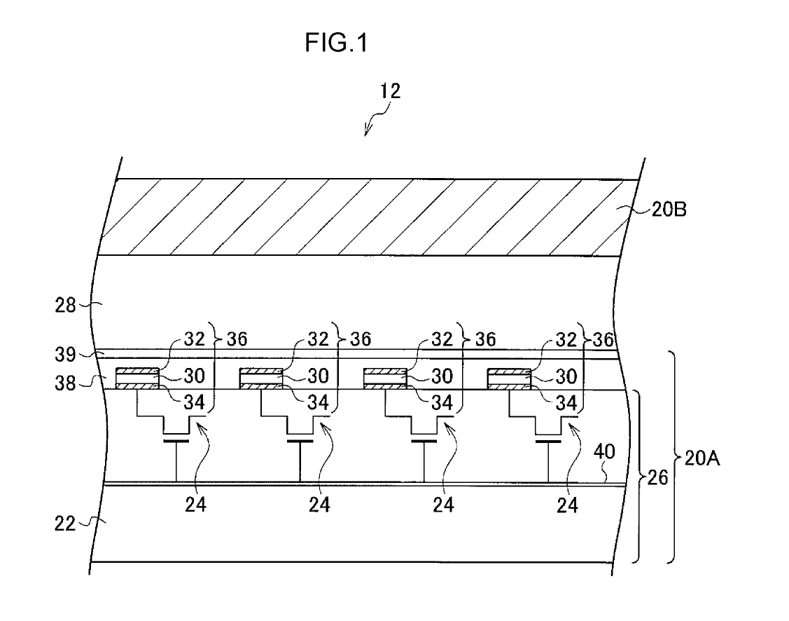

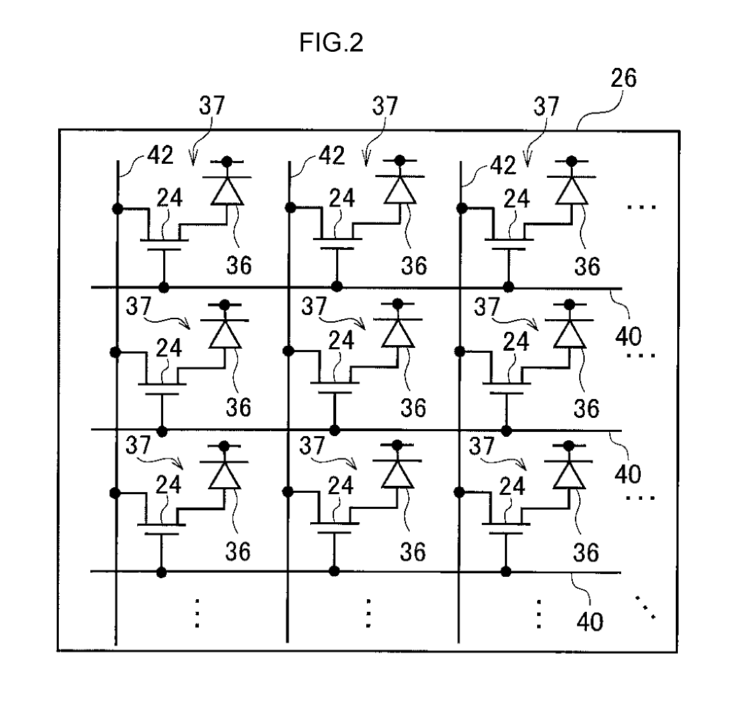

FIG. 1 is a cross-section view schematically illustrating a configuration of the radiation detector 12 according to the present exemplary embodiment, and FIG. 2 is a planar view illustrating the configuration of the radiation detector 12.

As shown in FIG. 1, the radiation detector 12 is configured with a scintillator layer 28 interposed between photodetectors 20A and 20B. Only the photodetector 20A will be explained below since the photodetectors 20A and 20B each have a similar configuration to each other. Details regarding the photodetector 20B are also omitted from FIG. 1.

The photodetector 20A includes a TFT substrate 26 of an insulating substrate 22 formed with switching devices 24 such as Thin Film Transistors (TFTs).

The scintillator layer 28 serves as an example of a radiation wave length converting layer for converting incident radiation and is formed above the TFT substrate 26 for converting incident radiation into light.

Examples of materials that may be employed for the scintillator layer 28 include such materials as CsI:Tl, CsI:Na, NaI:Tl and GOS (Gd₂O₂S:Tb). However, the scintillator layer 28 is not limited to the one formed from such materials.

Any material that transmits light and has low radiation absorption may be employed for the insulating substrate 22, with examples that may be employed including a glass substrate, a transparent ceramic substrate, and a resin substrate which transmits light. The insulating substrate 22 is, however, not limited to one formed from such materials.

A photoconductive layer 30 is interposed between the scintillator layer 28 and the TFT substrate 26. The photoconductive layer 30 generates charges when incident with light that was converted by the scintillator layer 28. Bias electrodes 32 for applying a bias voltage to the photoconductive layer 30 are formed on the surface of the photoconductive layer 30 which faces the scintillator layer 28.

Charge collection electrodes 34 are formed on the TFT substrate 26 for collecting charges generated in the photoconductive layer 30. In the TFT substrate 26, the charges collected in each of the charge collection electrodes 34 is read out by the respective switching device 24.

As shown in FIG. 2, there are plural pixels 37 disposed in a two-dimensional array on the TFT substrate 26, along a specific direction (rows in FIG. 2) and a cross direction to the specific direction (columns in FIG. 2). Each of the pixels 37 is configured including a sensor section 36 that is configured by the bias electrode 32, the photoconductive layer 30 and the charge collection electrode 34 and functions as a photodiode generating charges according to incident light, and the switching device 24 that reads charges accumulated in the sensor section 36.

Plural gate lines 40 are provided to the TFT substrate 26 so as to extend along the specific direction (rows) for switching each of the switching devices 240N or OFF, and plural data lines 42 are provided to the TFT substrate 26 so as to extend along a cross direction to the specific direction (columns) for reading charges out using the switching devices 24.

A flattening layer 38 (see FIG. 1) is also formed on the TFT substrate 26 for flatting the surface above the TFT substrate 26. A bonding layer 39 is also formed on the flattening layer 38 and between the TFT substrate 26 and the scintillator layer 28 for bonding the scintillator layer 28 to the TFT substrate 26.

The TFT substrate 26 has a flat plate shape with a quadrangular shape with four outside edges in plan view. A more specific example of the TFT substrate 26 has a rectangular shape. The TFT substrate of the photodetector 20A is referred to below as the TFT substrate 26A and the TFT substrate of the photodetector 20B is referred to below as the TFT substrate 26B.

While omitted in FIG. 1, the photodetector 20B is formed above the scintillator layer 28 such that its sensor sections 36 are disposed on the scintillator layer 28 side.

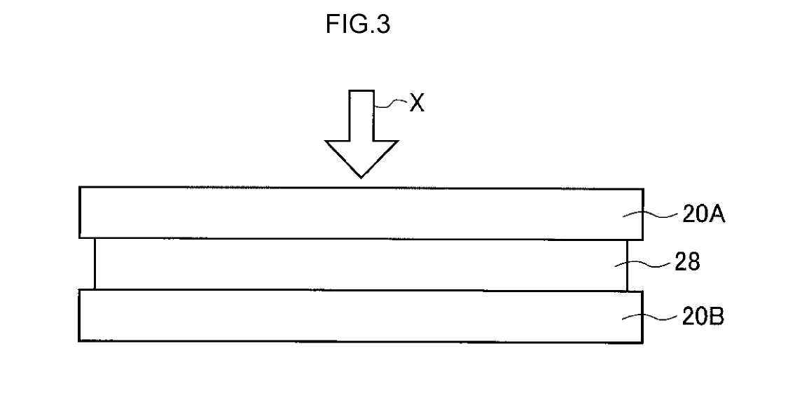

The radiation detector 12, as shown in FIG. 3, may have radiation irradiated from the photodetector 20A side or may have radiation irradiated from the photodetector 20B side, however in the present exemplary embodiment radiation is incident from the photodetector 20A side.

When radiation is being irradiated from the photodetector 20A side, the radiation detector 12 has more intense light generation on the photodetector 20A side of the scintillator layer 28 and weaker light generation on the photodetector 20B side of the scintillator layer 28. However, due to the region of the scintillator layer 28 where there is weaker light generation being disposed in the vicinity of the photodetector 20B, the light detection efficiency can be improved in comparison to a conventional configuration with a photodetector provided on only one face of the scintillator layer 28.

Similarly, when radiation is irradiated from the photodetector 20B side, there is more intense light generation on the photodetector 20B side of the scintillator layer 28 and weaker light generation on the photodetector 20A side of the scintillator layer 28. However, the region of the scintillator layer 28 where there is weaker light generation is in the vicinity of the photodetector 20A. Hence, in either case, the light detection efficiency can be improved in comparison to the configuration of a conventional photodetector provided on only one face of the scintillator layer 28.

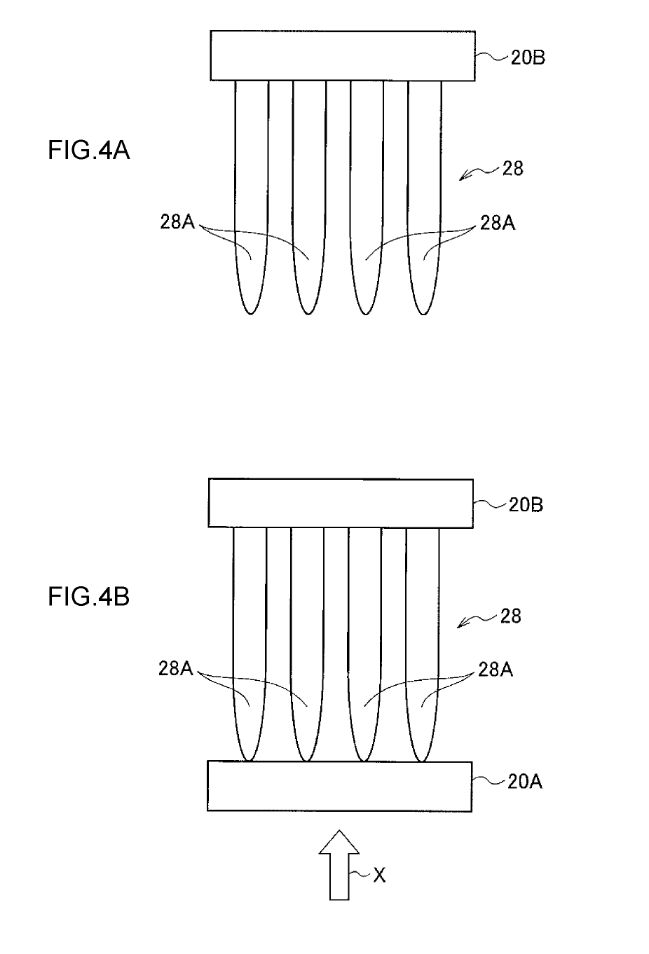

As stated above, the scintillator layer 28 may be configured with CsI:Tl, CsI:Na, or NaI:Tl. In such cases, as shown in FIG. 4A, the scintillator layer 28 is configured with columnar crystals 28A formed from one of CsI:Tl, CsI:Na, or NaI:Tl. The columnar crystals 28A can be formed by deposition on the photodetector 20B that serves as a support member. Then, as shown in FIG. 4B, the photodetector 20A is, for example, optically coupled to the leading end of the columnar crystals 28A.

The radiation incidence efficiency can be improved in such cases due to the radiation incident side-photodetector 20A being disposed at the leading end of the columnar crystals 28A, thereby improving the quality of radiographic images obtained.

The scintillator layer 28 may also, as stated above, be configured by GOS (Gd₂O₂S:Tb). In this case GOS (Gd₂O₂S:Tb) can be applied on either the photodetector 20A or the photodetector 20B and cured (hardened), then the remaining photodetector of the photodetector 20A and the photodetector 20B can be stuck for example using an adhesive sheet.

Explanation follows regarding a configuration of an electronic cassette 10 installed with the radiation detector 12.

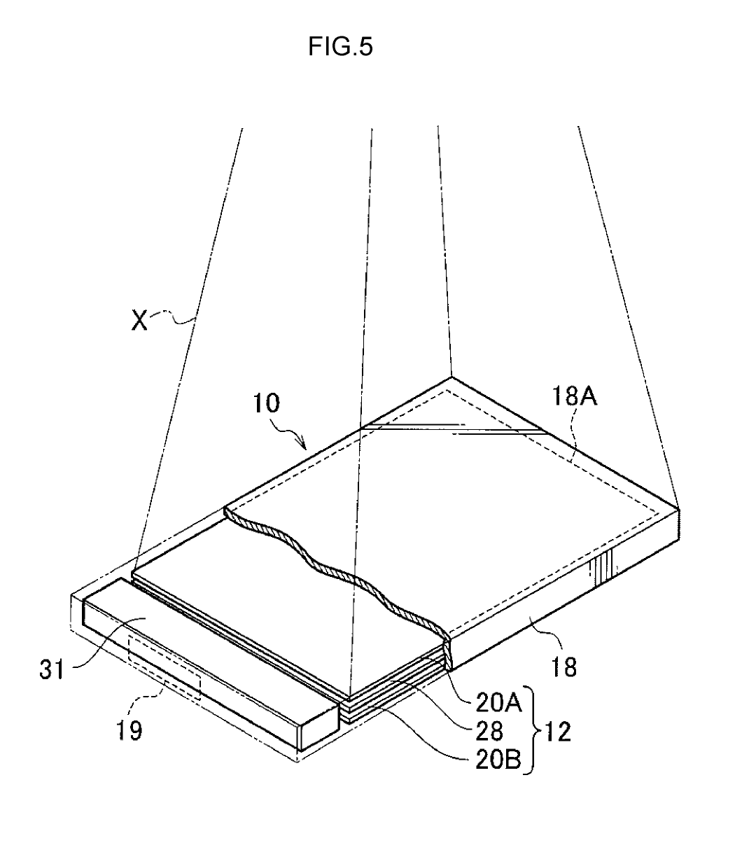

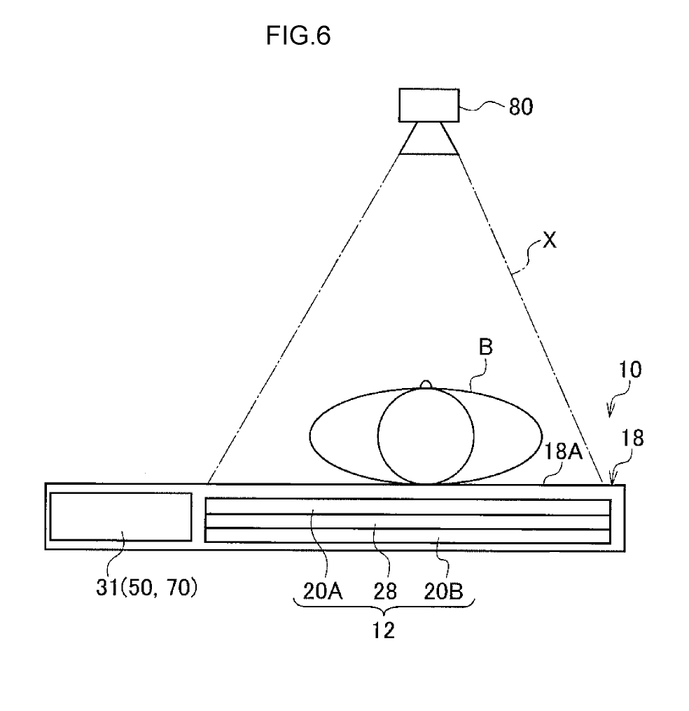

FIG. 5 is a perspective view illustrating a configuration of the electronic cassette 10, and FIG. 6 is a cross-section view of the electronic cassette 10.

The electronic cassette 10 is provided with a housing 18 formed in a flat plate shape from a material that allows radiation X to pass through. The construction of the electronic cassette 10 is water proof and tightly sealed. The above radiation detector 12 is disposed inside the housing 18. On one face of the flat plate shape of the housing 18, the region corresponding to the position where the radiation detector 12 is disposed, is configured as an image capture region 18A onto which radiation is irradiated during imaging. The radiation detector 12 is installed in the housing 18 such that the photodetector 20A is disposed on the image capture region 18A side.

A case 31 for accommodating a controller 50 and a power section 70, which are described later, is disposed at one end inside the housing 18, at a position that does not overlap with the radiation detector 12 (a position outside the range of the image capture region 18A). In order to enable the electronic cassette 10 for radiographic image capture with the image capture region 18A, components such as the circuits and elements which affect the radiographic images are not disposed inside the image capture region 18A.

The electronic cassette 10 also has an operation panel 19 provided with various buttons on a side face of the housing 18.

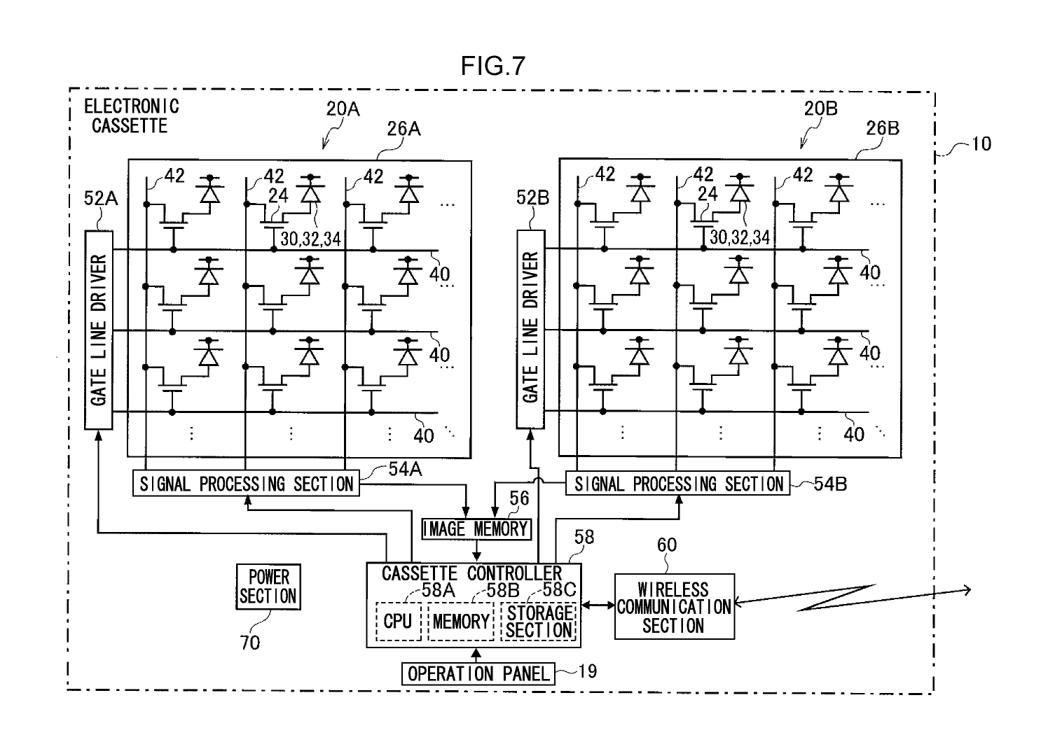

FIG. 7 is a block diagram illustrating a configuration of relevant parts of an electrical system of the electronic cassette 10.

Gate line drivers 52A and 52B, serving as first and second drive circuits, are disposed in the photodetectors 20A and 20B respectively on one of two adjacent sides, and signal processing sections 54A and 54B, serving as first and second read-out circuits, are disposed on the other of the two adjacent sides of the photodetectors 20A and 20B. The individual gate lines 40 of the photodetector 20A are connected to the gate line driver 52A, the individual data lines 42 of the photodetector 20A are connected to the signal processing section 54A, the individual gate lines 40 of the photodetector 20B are connected to the gate line driver 52B and the individual data lines 42 of the photodetector 20B are connected to the signal processing section 54B.

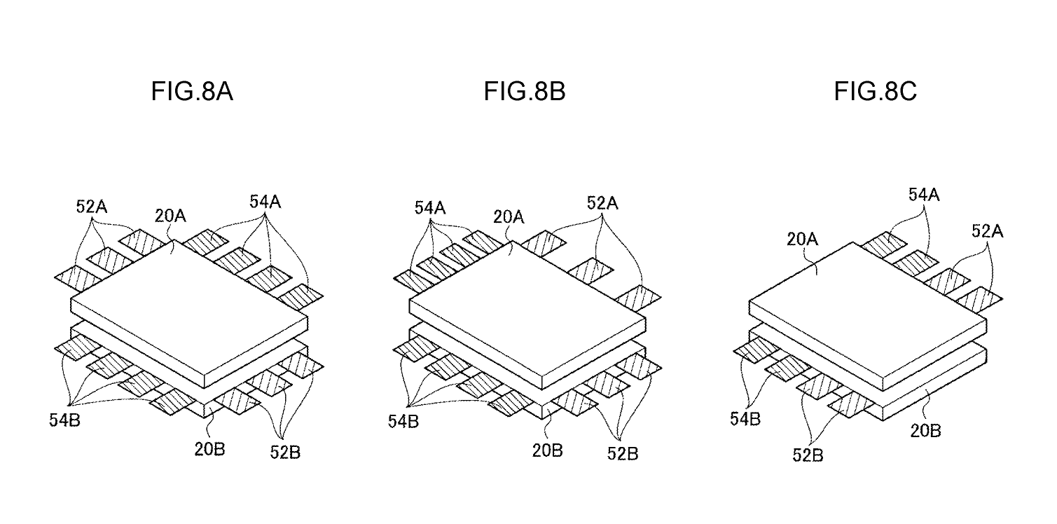

Due to the photodetectors 20A and 20B being disposed so as to face each other, there is a concern that circuits of the gate line drivers 52A and 52B and the signal processing sections 54A and 54B may interfere with each other. Hence, as shown in FIG. 8A, FIG. 8B and FIG. 8C, preferably the gate line drivers 52A and 52B and the signal processing sections 54A and 54B are disposed so as not to face each other. FIG. 8A to FIG. 8C illustrate examples in which there are plural of each of the gate line drivers 52A and 52B and the signal processing sections 54A and 54B provided.

An image memory 56, a cassette controller 58, and a wireless communication section 60 are provided as the controller 50 inside the housing 18.

Each of the switching devices 24 in the TFT substrates 26A and 26B are switched ON in sequence per row by signals fed from the gate line drivers 52A and 52B through the gate lines 40. Charges read out from the switching devices 24 that have been placed in the ON state are conveyed as an electrical signal through the data lines 42 and input to the signal processing sections 54A, 54B. Charge is thereby read out in sequence per row, enabling a radiographic image of a two dimensional array to be acquired.

While omitted in the drawings, each of the signal processing sections 54A and 54B is provided with an amplification circuit that amplifies input electrical signals and a sample and hold circuit for each of the individual data lines 42. The electrical signals transmitted through the individual data lines 42 are amplified by the amplification circuits and then held in the sample and hold circuits. A multiplexer and an analogue to digital (A/D) converter are connected in sequence at the output side of the sample and hold circuits. The electrical signals held by the individual sample and hold circuits are input (serially) in sequence to the multiplexer, and converted into image data by the A/D converter.

The image memory 56 is connected to the signal processing sections 54A and 54B, and image data output from the A/D converters of the signal processing sections 54A and 54B is stored in sequence in the image memory 56. The image memory 56 has sufficient capacity to enable image data for a specific number of frames to be stored. Each time a radiographic image is captured, the image data obtained by imaging is stored in sequence in the image memory 56.

The image memory 56 is connected to the cassette controller 58. The cassette controller 58 configured by a microcomputer includes a Central Processing Unit (CPU) 58A, a memory section 58B including ROM and RAM, and a non-volatile storage section 58C formed, for example, by flash memory. The cassette controller 58 controls the overall operation of the electronic cassette 10.

The wireless communication section 60 is connected to the cassette controller 58. The wireless communication section 60 is compatible with a wireless Local Area Network (LAN) standard, typified by a standard such as Institute of Electrical and Electronics Engineers (IEEE) 802.11a/b/g, and operates transmission of various data by wireless communication to and from external equipment. The cassette controller 58 is enabled for wireless communication through the wireless communication section 60 with an external device for controlling radiographic image capture overall, such as a console. The cassette controller 58 has capability to transmit and receive various data to and from the console.

The cassette controller 58 individually controls operation of the gate line drivers 52A and 52B, and is capable of individually controlling read out of image data expressing a radiographic image from the photodetectors 20A and 20B. The cassette controller 58 stores various data, such as image capture conditions, received from a console through the wireless communication section 60, and controls the gate line drivers 52A and 52B, and reads out images from the photodetectors 20A and 20B according to the image capture conditions.

The operation panel 19 is also connected to the cassette controller 58, and the cassette controller 58 is accordingly able to ascertain the contents of operation to the operation panel 19.

The power section 70 is provided in the electronic cassette 10, and each of the circuits and each of the elements described above (the operation panel 19, the gate line drivers 52A and 52B, the signal processing sections 54A and 54B, the image memory 56, the wireless communication section 60, and the microcomputer functioning as the cassette controller 58) are operated by power supplied from the power section 70. In order not to compromise the portability of the electronic cassette 10, the power section 70 is installed with a battery (a rechargeable secondary battery) and supplies power from the charged battery to each of the circuits and elements. Wiring lines connecting the power section 70 to the various circuits and various elements are omitted in FIG. 7.

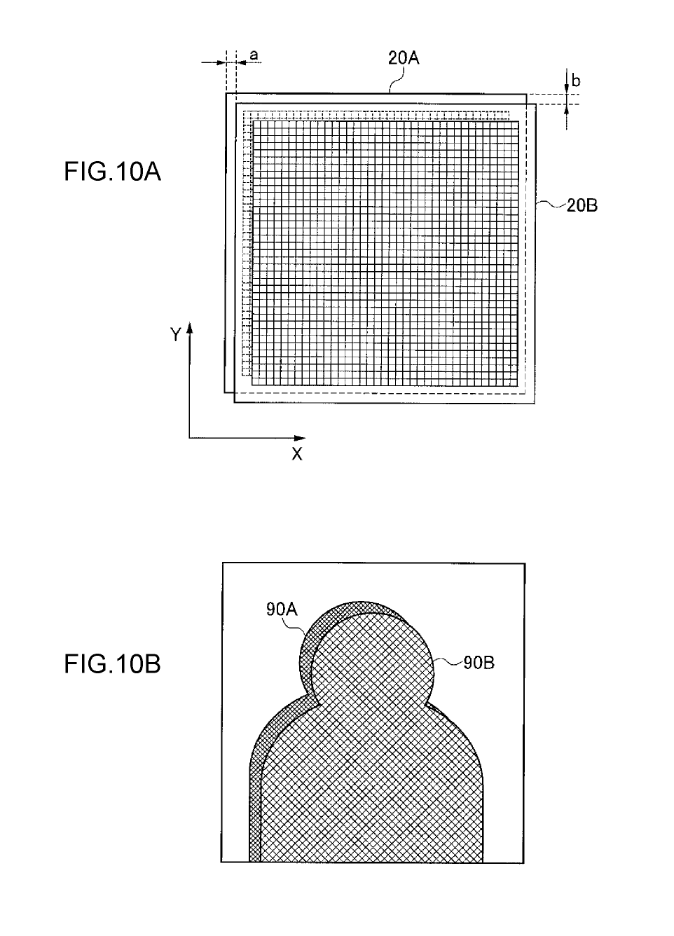

Due to the scintillator layer 28 being interposed between the photodetectors 20A and 20B in the radiation detector 12, as described above, there may be misalignment between the photodetector 20A and the photodetector 20B along a face direction, as shown in FIG. 10A. When image data read with the photodetector 20A and image data read with the photodetector 20B is synthesized with the imaging subject misaligned, deterioration in quality of the synthesized image results. However, a precise alignment of the photodetectors 20A and 20B during manufacture would lead to a rise in cost and reduced yield rate.

In the present exemplary embodiment, as will be explained in detail later, the image data read with the photodetector 20A and the image data read with the photodetector 20B are synthesized so as to eliminate misalignment, with synthesization being performed according to misalignment amount data expressing the misalignment amount in a face direction between the photodetector 20A and the photodetector 20B. The misalignment amount data includes data of the number of pixels worth by which the photodetector 20B is misaligned with respect to the photodetector 20A in a predetermined x-direction, and/or data of the number of pixels worth by which the photodetector 20B is misaligned with respect to the photodetector 20A in a y-direction orthogonal to the x-direction. The misalignment amount data is, for example, measured during manufacture of the radiation detector 12 and stored in advance in the storage section 58C.

Explanation follows regarding operation of the electronic cassette 10 according to the present exemplary embodiment.

The electronic cassette 10, as shown in FIG. 6, is disposed with a space to a radiation generation device 80 for generating radiation, and the imaging site B of a patient is disposed over the image capture region. The radiation generation device 80 emits radiation at a radiation dose in accordance with the image capture conditions pre-notified to the radiation generation device 80. The radiation X emitted from the radiation generation device 80 is irradiated onto the electronic cassette 10 with carrying image data by passing through the imaging site B.

The radiation X irradiated from the radiation generation device 80 reaches the electronic cassette 10 after it has passed through the imaging site B. Charges are accordingly collected and accumulated in each of the charge collection electrodes 34 of the radiation detector 12 installed in the electronic cassette 10 according to the amount of radiation X irradiated thereon.

When irradiation of the radiation X has been completed, the cassette controller 58 performs image read processing to read out an image.

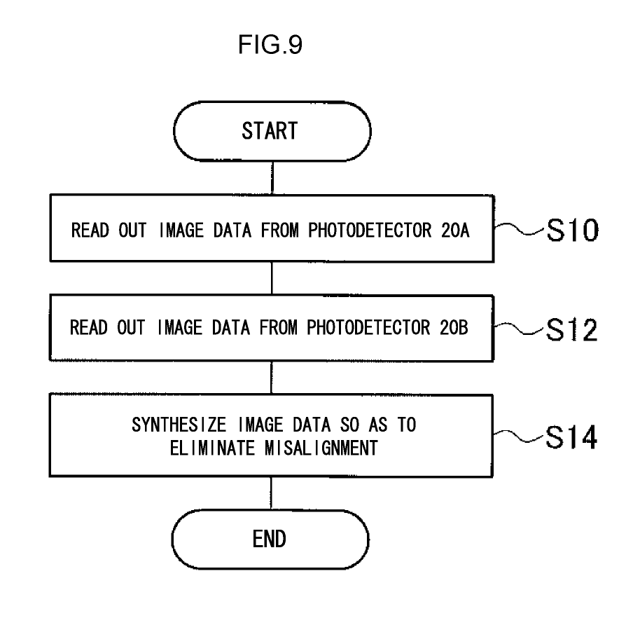

FIG. 9 is a flow chart illustrating the flow of processing of an image read out processing program executed by the CPU 58A. This program is stored in advance in a specific region of ROM in the cassette controller 58.

Image information is read out from the photodetector 20A in step S10. Namely, the gate line driver 52A is controlled and ON signals are output one line at a time from the gate line driver 52A to each of the gate lines 40, and image data reading is performed. The image data read out from the photodetector 20A is stored in the image memory 56.

Image data is read out from the photodetector 20B in step S12. Namely, the gate line driver 52B is controlled and ON signals are output one line at a time from the gate line driver 52B to each of the gate lines 40, and image data reading is performed. The image data read from the photodetector 20B is stored in the image memory 56.

Then at step S14, based on misalignment amount data stored in the storage section 58C, the image data read from the photodetector 20A and the image data read from the photodetector 20B is synthesized so as to eliminate any misalignment between the photodetector 20A and the photodetector 20B along the face direction.

As shown in FIG. 10A, if, for example, the photodetector 20B is misaligned with respect to the photodetector 20A by +a pixels worth in the x-direction and −b pixels worth in the y-direction, image data read from the photodetector 20B is synthesized with the image data read from the photodetector 20A after being shifted by −a pixels worth in the x-direction and +b pixels worth in the y-direction.

The image data read from the photodetector 20A and the image data read from the photodetector 20B are accordingly combined without misalignment.

In the present exemplary embodiment, misalignment amount data along the face direction between the photodetector 20A and the photodetector 20B is measured and stored in advance, and the image data read from the photodetector 20A and the image data read from the photodetector 20B are synthesized with each other according to this misalignment amount data. This results in there being no need to compute a misalignment amount for each time of image capture. Hence a synthesized image can be obtained with a simplified processing so that misalignment is eliminated with good precision.

Note that tilt angle data, indicating any tilting of the photodetector 20B to the photodetector 20A resulting from inclination of the photodetectors resulting from uneven layer thickness in the scintillator layer, may be combined with the misalignment amount data.

In such cases, if, for example, the photodetector 20B is inclined by θ degrees with respect to the photodetector 20A, the image data read from the photodetector 20A is combined with the image data read from the photodetector 20B multiplied by (1−sin θ)^{1/2}.

While explanation has been given in the present exemplary embodiment of cases in which the misalignment amount data is measured and pre-stored in the storage section 58C during manufacture, embodiments are not limited thereto and the misalignment amount data may be computed. For example, when a predetermined reference image is captured, any pixel values (signal values) different from other pixels in the image data read from the photodetector 20A and image data read from the photodetector 20B may be marked, and the misalignment amount computed from the position of the respective marks. For example, an image disposed with a mark at a predetermined position can be used as a reference image. The mark can then be detected respectively in the image data read from the photodetector 20A and the image data read from the photodetector 20B, and the misalignment amount computed based on the detected marks and stored. When this approach is adopted, there is no need to compute the misalignment amount for every time of image capture.

An empty image, namely a solid image, may also be employed as a reference image. When this approach is adopted, an image is captured with no subject present, and the position of pixels having pixel values different to the pixel values when a normal solid image is captured are detected in the image data read from the photodetector 20A and the image data read from the photodetector 20B, respectively. The positions of such pixels correspond to the position of pixels where pixel defects are present, namely positions of defects in the scintillator layer 28. Computing the misalignment amount using the position of pixel defects as markers and storing this misalignment amount negates the need to compute the misalignment amount for each time of image capture in such cases too.

Known pattern recognition processing may also be executed on the image data read from the photodetector 20A and the image data read from the photodetector 20B when an image of a normal subject, such as a person, has been captured. As shown in FIG. 10B, the misalignment amount can be computed based on the positions of subjects 90A and 90B extracted from the respective image data. Storing the computed misalignment amount in such cases also negates the need to compute the misalignment amount for every time of image capture.

The present invention has been explained by way of exemplary embodiment. However, the technical scope of the present invention is not limited by scope of the above exemplary embodiment. Various modifications and improvements are possible to the above exemplary embodiment in a range not departing from the spirit of the invention, and such modifications and improvements are also included in the technical scope of the present invention.

Furthermore, the above exemplary embodiment does not limit the invention of the claims, and a combination of all the features explained in the exemplary embodiment is not necessarily essential for other embodiments of the invention. Various levels of invention are included in the exemplary embodiments referred to above, and the invention may be implemented by various appropriate combinations of the plural configuration elements disclosed. Even when some of the configuration conditions are omitted from out of the total configuration conditions illustrated in the above exemplary embodiments, as long as an effect is obtained, the invention is obtained as extracted by the configuration with those of configuration elements omitted.

In the exemplary embodiment above, explanation has been given of cases in which application is made to an electronic cassette 10 that is a portable radiographic image capture device. However, embodiments are not limited thereto and application may also be made to a fixed radiographic image capture device.

Furthermore, while in the above exemplary embodiments explanation has been given of cases of application of the present invention to a radiographic image capture device for capturing a radiographic image by detecting radiation of X-rays, embodiments are not limited thereto. For example, the radiation subject to detection may be radiation other than X-rays, such as visible light, UV light, infrared light, gamma radiation or a particle beam.

The electronic cassette 10 and the radiation detector 12 explained in the above exemplary embodiment are merely examples thereof, and changes may be made within a scope not departing from the spirit of the present invention.

What is claimed is:

1. A radiographic image capture device comprising:
a wavelength conversion layer that converts radiation that has passed through an imaging subject into visible light;
a first photodetector that detects the converted visible light and that converts the converted visible light into a first image signal expressing a radiographic image;
a second photodetector that detects the converted visible light and that converts the converted visible light into a second image signal expressing a radiographic image; and
a synthesizing section that combines the first image signal read from the first photodetector and the second image signal read from the second photodetector such that misalignment between the first and the second photodetectors is eliminated.

2. The radiographic image capture device of claim 1, wherein the wavelength conversion layer is interposed between the first and the second photodetectors.

3. The radiographic image capture device of claim 1, further comprising a storage section that stores in advance a misalignment amount between the first photodetector and the second photodetector,
wherein the synthesizing section synthesizes the first image signal and the second image signal according to the misalignment amount such that the misalignment is eliminated.

4. The radiographic image capture device of claim 1, wherein the synthesizing section synthesizes the first image signal and the second image signal such that the misalignment is eliminated based on a position of a pixel having a different signal value from other pixels in a first reference image signal of a reference image detected by the first photodetector and in a second reference image signal of the reference image detected by the second photodetector.

5. The radiographic image capture device of claim 1, wherein the synthesizing section synthesizes the first image signal and the second image signal such that the misalignment is eliminated according to results of pattern recognition performed on the first image signal and the second image signal when an image of an imaging subject is captured.

6. The radiographic image capture device of claim 1, wherein the misalignment is a misalignment along a face direction of the first photodetector and the second photodetector.

7. The radiographic image capture device of claim 1, wherein the wavelength conversion layer is configured with columnar shaped crystals of CsI:Tl, CsI:Na, or NaI:Tl, deposited on a support member of one of the first photodetector or the second photodetector.

8. The radiographic image capture device of claim 7, wherein the other photodetector of the first photodetector and the second photodetector is disposed on a leading end side of the columnar shaped crystals and on a radiation incident side.

9. The radiographic image capture device of claim 1 wherein:
the first photodetector comprises a first drive circuit that drives the first photodetector and a first read-out circuit that reads out the first image signal;
the second photodetector comprises a second drive circuit that drives the second photodetector and a second read-out circuit that reads out the second image signal; and
the first drive circuit and the first read-out circuit are disposed so as not to face the second drive circuit or the second read-out circuit.

10. A radiographic image capture method comprising:
reading out a first image signal expressing a radiographic image from a first photodetector that detects visible light, which has been converted by a wavelength conversion layer into visible light from radiation that has passed through an imaging subject, and that converts the detected visible light into the first image signal;
reading out a second image signal expressing a radiographic image from a second photodetector that detects visible light, which has been converted by the wavelength conversion layer, and that converts the detected visible light into the second image signal; and
synthesizing the first image signal and the second image signal such that misalignment between the first and the second photodetectors is eliminated.

11. The radiographic image capture method of claim 10, further comprising storing in advance a misalignment amount between the first photodetector and the second photodetector, and combining the first image signal and the second image signal according to the misalignment amount stored in advance such that the misalignment is eliminated.

12. The radiographic image capture method of claim 10, wherein the first image signal and the second image signal are synthesized such that the misalignment is eliminated based on a position of a pixel having a different signal value from other pixels in a first reference image signal of a reference image detected by the first photodetector and in a second reference image signal of the reference image detected by the second photodetector.

13. The radiographic image capture method of claim 10, wherein the first image signal and the second image signal are synthesized such that the misalignment is eliminated according to results of pattern recognition performed on the first image signal and the second image signal when an image of an imaging subject is captured.

14. The radiographic image capture method of claim 10, wherein the misalignment is a misalignment along a face direction of the first photodetector and the second photodetector.

15. A non-transitory storage medium storing a program that causes a computer to execute radiographic image capture processing, the radiographic image capture processing comprising:
reading out a first image signal expressing a radiographic image from a first photodetector that detects visible light, which has been converted by a wavelength conversion layer into visible light from radiation that has passed through an imaging subject, and that converts the detected visible light into the first image signal;
reading out a second image signal expressing a radiographic image from a second photodetector that detects visible light, which has been converted by the wavelength conversion layer, and that converts the detected visible light into the second image signal; and
synthesizing the first image signal and the second image signal such that misalignment between the first and the second photodetectors is eliminated.

16. The non-transitory storage medium of claim 15, wherein the radiographic image capture processing further comprises storing in advance a misalignment amount between the first photodetector and the second photodetector, and combining the first image signal and the second image signal according to the misalignment amount stored in advance such that the misalignment is eliminated.

17. The non-transitory storage medium of claim 15, wherein the first image signal and the second image signal are synthesized such that the misalignment is eliminated based on a position of a pixel having a different signal value from other pixels in a first reference image signal of a reference image detected by the first photodetector and in a second reference image signal of the reference image detected by the second photodetector.

18. The non-transitory storage medium of claim 15, wherein the first image signal and the second image signal are synthesized such that the misalignment is eliminated according to results of pattern recognition performed on the first image signal and the second image signal when an image of an imaging subject is captured.

19. The non-transitory storage medium of claim 15, wherein the misalignment is a misalignment along a face direction of the first photodetector and the second photodetector.
